(19) United States
(12) Patent Application Publication
(10) Pub. No.: US 2002/0045967 A1
(43) Pub. Date: Apr. 18, 2002

(54) Substrate processing system

(76) Inventors: Masayuki Nakano, Tokyo-To (JP); Yoichi Deguchi, Tokyo-To (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/974,822

(22) Filed: Oct. 12, 2001

(30) Foreign Application Priority Data
Oct. 17, 2000 (JP) 2000-316815

(51) Int. Cl. G06F 19/00

(52) U.S. Cl. 700/121

(57) ABSTRACT

A predetermined process is provided to a substrate, a plurality of processing apparatuses, each having a controller, are connected to a host computer in a ring shape, and the transfer of substrate is performed according to each processing apparatus. Transfer mechanism, each having no controller, are directly connected to the host computer independently of the respective processing apparatuses, and execute the operation under direct control from the host computer. Accordingly, even if a cable for connecting the host computer to the respective processing apparatuses is damaged, the processes for substrate can be carried safely without exerting an influence upon the operation of each transfer mechanism.

### BACKGROUND OF THE INVENTION

1. Field of the Invention

The present invention relates to a substrate processing system that controls processing apparatuses for providing predetermined processes to a substrate such as a semiconductor wafer.

2. Description of the Related Art

In recent years, there has been a growing trend to automate and robotize substrate processing apparatuses such as a semiconductor manufacturing apparatus, a liquid crystal display manufacturing apparatus and the like in accordance with improvement in performance of a microcomputer. For example, there have been developed various kinds of manufacturing apparatuses of a combined process type that automates the operations including the transfer of a wafer to the loading thereof onto the respective processing apparatuses by coupling with the transfer mechanism such as a robot, the respective processing apparatuses such as a coating apparatus, a developing apparatus that provide processing solution onto the substrate, and a heating apparatus. In such a manufacturing apparatus, the respective processing apparatus and transfer mechanism have controllers individually, and they are connected to a host computer in a ring shape. The host computer entirely and generically manages data relating to temperature and time of each processing apparatus, and data relating to the position of substrate obtained from the transfer mechanism, and aims to execute each process/transfer of the substrate.

However, in such a control system, there is a case in which a ring cable between the host computer and the transfer mechanism is troubled after sending an operation start command to the transfer mechanism from the host computer and before receiving an operation end command. As a result, the transfer mechanism continues to operate without receiving the operation end command. Namely, for example, there is a possibility that the transfer mechanism runs away without receiving any command so as to cause damage to each processing apparatus. In the case where one of the processing apparatuses is troubled by some cause, and is out of control, this may exert an adverse influence upon the system, and particularly, there is a fear that the transfer mechanism will run away.

### SUMMARY OF THE INVENTION

An object of the present invention is to provide a safe control system wherein transfer mechanism do not run away even if a ring cable is damaged or a processing apparatus is out of control.

In order to achieve the above object, according to the present invention, there is provided a substrate processing system comprising a processing apparatus for providing a predetermined process to a substrate, a host computer for controlling the system entirely and generically, a controller, being provided corresponding to the processing apparatus and causes the processing apparatus to perform the process based on a request from the host computer, and a transfer mechanism, being directly controlled from the host computer and loads/unloads the substrate to/from at least the processing apparatus.

According to the above structure, since the transfer mechanism are directly controlled by the host computer, the processes for the substrate can be carried out safely without exerting an influence upon the operations of the transfer mechanism even if a cable for connecting the host computer to the processing apparatuses are damaged. Moreover, even if the cable that connects the host computer with the processing apparatuses is damaged, the transfer mechanisms go down themselves. As a result they do not run away, thus making it possible to carry out the processes for the substrate safely.

In order to achieve the above object, according to the present invention, there is provided a substrate processing system comprising, a plurality of first processing apparatuses supplying a predetermined solution onto a substrate while the substrate is being rotated, a plurality of second processing apparatuses providing a thermal processing to the substrate, a host computer controlling the system entirely and generically, a plurality of first controllers, being provided corresponding to the first processing apparatuses and being connected to said host computer in a bus shape and causes the corresponding first processing apparatuses to perform the process based on a request from the host computer, a plurality of second controllers, being provided corresponding to the second processing apparatuses and being connected to the host computer in a ring shape and causing the second processing apparatuses to execute the corresponding process based on a request from said host computer, and a transfer mechanism being directly controlled by the host computer and loads/unloads the substrate to/from at least the first and second processing apparatuses.

According to the above structure, the host computer is connected to the plurality of first processing apparatuses in a bus shape. For this reason, even if connection to at least one of the plurality of first processing apparatuses is damaged, this damage does not have an adverse influence upon the other processing apparatuses. Particularly, the runaway of rotational operation can be prevented.

These objects, other objects and advantages of the present invention will become readily apparent by the following description and the accompanying drawings.

### BRIEF DESCRIPTION OF THE DRAWINGS

FIG. 1 is a plane view illustrating the structure of a resist coating and developing system according to one embodiment of the present invention;

FIG. 2 is a front view of the resist coating and developing system illustrated in FIG. 1;

FIG. 3 is a back view of the resist coating and developing system illustrated in FIG. 1;

FIG. 4 is a cross-sectional view illustrating the flow of clean air in the resist coating and developing system illustrated in FIG. 1;

FIG. 5 is a partially broken perspective view illustrating a transfer mechanism in the resist coating and developing system illustrated in FIG. 1;

FIG. 6 is a plane view illustrating a heating apparatus in the resist coating and developing system illustrated in FIG. 1;

FIG. 7 is a plane view illustrating a coating apparatus in the resist coating and developing system illustrated in FIG. 1;

FIG. 8 is a structural view of a control system where a ring-type connection is established according to the first embodiment of the present invention;

FIG. 9 is a view explaining the delivery of the substrate between transfer mechanisms according to the first embodiment of the present invention;

FIG. 10 is a view (part 1) explaining the operation of a clean air supply mechanism according to the first embodiment of the present invention;

FIG. 11 is a view (part 2) explaining the operation of a clean air supply mechanism according to the first embodiment of the present invention;

FIG. 12 is a view illustrating the structure of another heating apparatus to be incorporated into the resist coating and developing system illustrated in FIG. 1;

FIG. 13 is a structural view of a control system where a bus-type connection is established according to the second embodiment of the present invention;

FIG. 14 is a structural view of a control system where a ring-type and a bus-type connection are established according to the third embodiment of the present invention; and

FIG. 15 is a structural view of a power supply restricting system to the apparatuses of heat processing system in the control system of FIG. 14.

### DETAILED DESCRIPTION OF THE PREFERRED EMBODIMENT

Embodiments of the present invention will be specifically explained with reference to the drawings accompanying herewith.

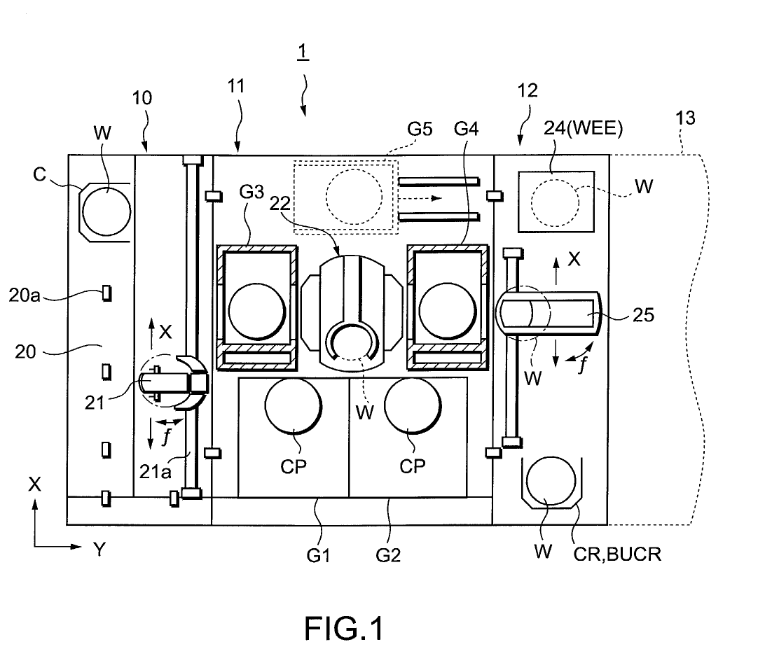

As illustrated in FIG. 1, a resist coating and developing system 1 comprises a cassette station 10, a processing station 11, and an interface section 12 connected to one another to form an integral structure in a system that coats and develops a chemically amplified resist onto a semiconductor wafer.

In the cassette station 10, as illustrated in FIG. 1, a plurality of cassettes C (for example, four) is placed in a line in positioning projections 20a on a cassette table 20 in the direction of X (vertically in FIG. 1) with wafer inlet and outlet facing the processing station 11. A transfer mechanism 21, which is movable in the direction of wafer C arrangement (direction X) and in the direction wafer W arrangement (direction Z: veridical direction) of wafers W contained in the cassette C, can freely move along a transfer path 21a and selectively access one of the cassettes C.

The transfer mechanism 21 is structured to be rotatable in the direction of θ. This transfer mechanism 21 is also able to access an alignment apparatus (ALIM) and an extension apparatus (EXT) belonging to the multistage apparatuses section of a third processing unit group G3 on the processing station 11 to be described later.

The processing station 11 has a main transfer mechanism 22 of a vertical transfer type in its center. Around the main wafer transfer mechanism, one or more groups of processing apparatuses are arranged as a processing chamber. Each group is made up of various processing apparatuses arranged in a multistage manner. In the resist coating and developing system of this embodiment, five processing unit groups G1, G2, G3, G4, ad G5 can be arranged. The first and second processing unit groups G1 and G2 are arranged in the front of the system, the third processing unit group G3 is arranged adjacent to the cassette station 10. The fourth processing unit group G4 is put adjacent to the interface section 12. Further, the fifth processing unit group G5 illustrated by a broken line is arranged at the back of the system. The main transfer mechanism 22 is structured to be rotable in the direction of θ, and movable in the direction of Z, so that the transfer of wafer W among the respective processing unit groups G1 to G5 is carried out.

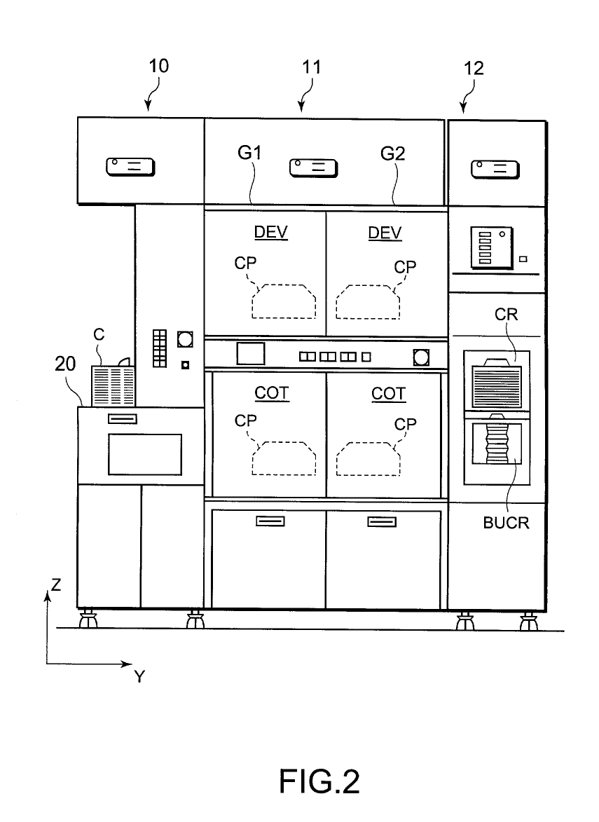

In the first processing unit group G1, as illustrated in FIG. 2, there are arranged two spinner-type processing apparatuses that place the wafer W on a spin chuck in a cup CP and perform predetermined processes. For example, a resist coating apparatus (COT) and a developing apparatus (DEV) are stacked in two stages. Then, similarly to the first processing unit group G1, in the second processing unit group G2, two spinner-type processing apparatuses, for example, a resist coating apparatus (COT) and a developing apparatus (DEV) are stacked in two stages.

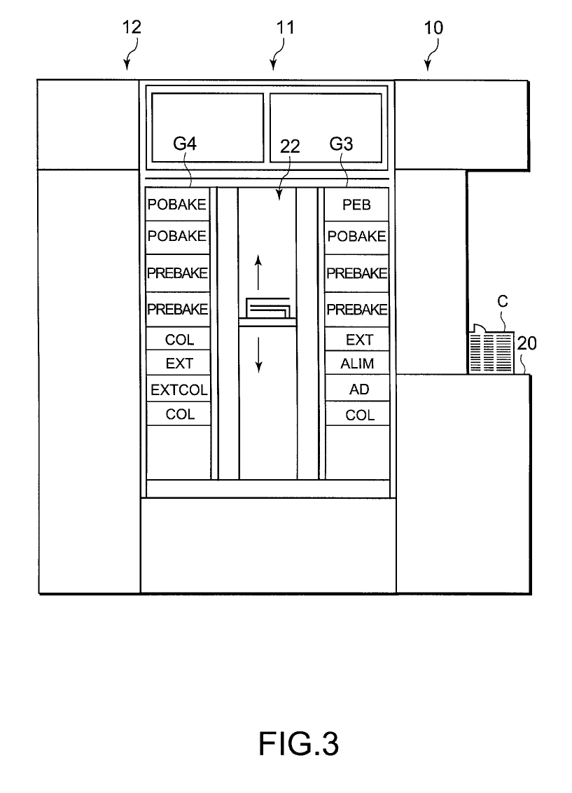

In the third processing unit group G3, as illustrated in FIG. 3, open-type processing apparatuses that place the wafer W on a carriage table (not shown) and perform predetermined processes. For example, a cooling apparatus (COL) that performs a cooling process, an adhesion processing apparatus (AD) that performs the so-called hydrophobic process to improve the fixation of resist, an alignment apparatus (ALIM) that performs alignment, an extension apparatus (EXT), a pre-baking apparatus (PREBAKE) that performs a heating process before exposure, a post baking apparatus (POBAKE), and a post exposure baking apparatus (PEB) are stacked, for example, in eight stages from the bottom.

Similarly, in the fourth processing unit group G4, open-type processing apparatuses that place the wafer W on a carriage table and perform predetermined processes. For example, a cooling apparatus (COL), an extension/cooling apparatus (EXTCOL) that also performs a cooling process, an extension apparatus (EXT), an adhesion processing apparatus (AD), a pre-baking apparatus (PREBAKE), and a post baking apparatus (POBAKE) are stacked, for example, in eight stages from the bottom.

As illustrated in FIG. 1, the interface section 12 has the same length in the direction of depth (in the direction of X) as that of the processing station 11, but is shorter in the direction of width. As illustrated in FIGS. 1 and 2, a movable pick-up cassette CR and a stationary buffer cassette (BUCR) are stacked in two stages at a front portion of the interface section 12, and a peripheral exposure apparatus 24 (WEE) is provided at the other rear portion thereof.

At the center of the interface section 12, there is provided a transfer mechanism 25. The transfer mechanism 25 is structured such that it is moved in the directions of X and Y (vertical direction) to be accessible to the both cassettes CR and BUR and the peripheral exposure apparatus (WEE) 24. The transfer mechanism 25 is also structured to be rotatable in the direction of θ, and accessible to the extension apparatus (EXT) (delivery mechanism) which belongs to the fourth processing unit group G4 located at the processing station 11 and to a wafer transfer table (not shown) located on the exposure apparatus side.

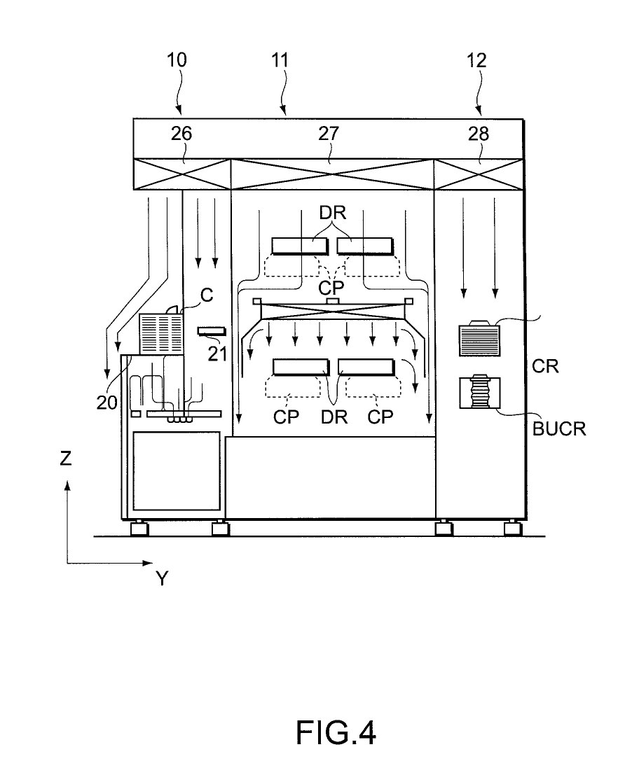

As illustrated in FIG. 4, a first clean air supply mechanism 26, a second clean air supply mechanism 27, and a third clean air supply mechanism 28 are provided on the upper portions of the cassette station 10, processing station 11, interface section 12, respectively. These clean air supply mechanisms 26 to 28 form a down-flow of clean air in the respective portions 10, 11, and 12.

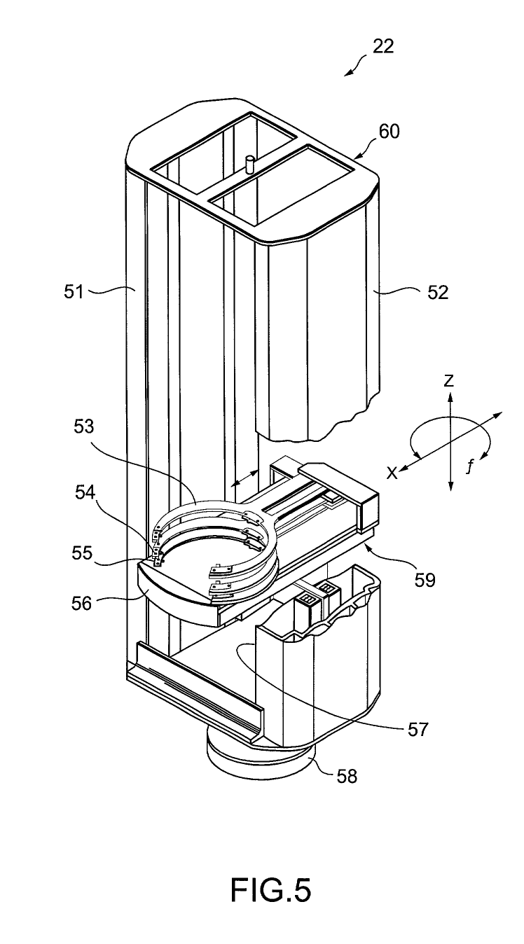

FIG. 5 is a perspective view illustrating the outline of the aforementioned main transfer mechanism 22.

This main transfer mechanism 22 has a wafer transferring portion 59, which is formed in a cylindrical support member 60 and which freely elevates up and down directions (direction of Z). The cylindrical support member 60 is composed of a pair of wall portions 51 and 52, which are connected to each other at upper and lower ends to be opposed to each other.

The cylindrical support member 60 is connected to a rotating shaft of a motor 58, and rotates about the rotating shaft with the wafer transferring portion 59 as one unit by the rotational driving force of the motor 58. Accordingly, the wafer transferring portion 59 is freely rotatable in the direction of θ.

On a transfer base 56 of the wafer transferring portion 59, for example, three arms 53, 54, and 55 are provided. Any of these arms 53 to 55 has a form and a size that can pass through a side surface opening portion 57 between both walls 51 and 52 of the cylindrical support member 60, and is freely movable back and forth along the direction of X.

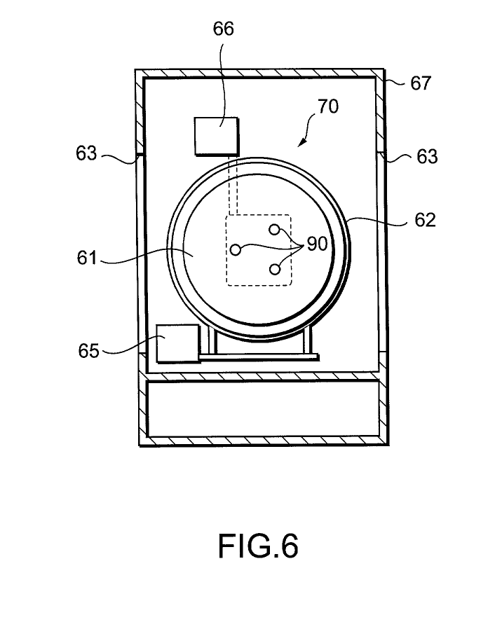

FIG. 6 is a plane view illustrating the aforementioned pre-baking apparatus (PREBAKE), and post baking apparatus (POBAKE) and so on.

A heating apparatus 70 is provided at the center of the processing unit. The heating apparatus 70 includes a heating plate 61, a ring shutter 62, three elevation pins 90, and a motor 66. The heating plate 61 heats the wafer W to a predetermined temperature. The ring shutter 62 surrounds the outer periphery of the heating plate 61 and is moved up and down by the motor 65 at the time of heating the wafer W. The elevation pins 90 are inserted into holes formed close to the center of the heating plate 61 and act as an intermediary at the time of transferring the wafer W to/from the main wafer transfer mechanism 22 or the first wafer transfer mechanism 21. The motor 66 elevates these pins 90.

The heating apparatus 70 is enclosed with a housing 67, and the housing 67 has an opening 63 for loading/unloading the wafer W onto/from the outer section on each of both sides of the housing 67.

Note that the structure of the cooling apparatus (COL) 28 is substantially the same as that of FIG. 6.

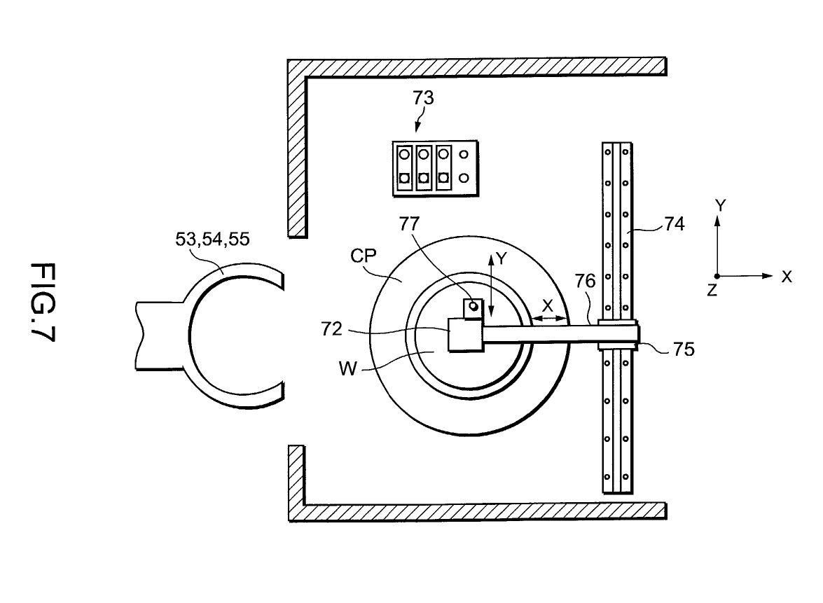

FIG. 7 is a plane view illustrating the aforementioned resist coating apparatus (COT).

The resist coating apparatus (COT) 25 is an apparatus that coats the resist on the wafer W. The resist coating apparatus (COT) 25 includes a cup CP, a spin chuck (not shown), a motor (not shown), guide rails 74, a scan arm 76, a nozzle 77, and a nozzle standby portion 73. The cup CP is provided close to the center of the apparatus and contains the wafer W. The spin chuck is provided in the cup CP and absorbs and holds the wafer W. The motor elevates this spin chuck up and down and rotates it at high speed. The guide rails 74 are laid on the side of cup CP. The scan arm 76 is formed to be movable in the direction of Y along the guide rails 74 and to be slidable in the direction X. The nozzle 77 is held by a holder 72 fixed to the scan arm 76, and supplies processing solution. The nozzle standby portion 73 is a place where the nozzle 77 is in a standby status.

Note that the developing apparatus (DEV) is also substantially the same as one that is illustrated in FIG. 7.

An explanation will be next given of the processing steps of the above-structured resist coating and developing system 1.

First, the wafer W is guided into the alignment apparatus (ALIM) of the third processing unit group G3 of the processing station 11 from the cassette station 10. Then, the wafer W is loaded from the alignment apparatus (ALIM) and is transferred to the adhesion processing apparatus (AD) of the third processing unit group G3.

Next, the wafer W is subjected to hydrophobic process by the adhesion processing apparatus (AD) of the third processing unit group G3, and the resultant wafer W is cooled by the cooling apparatuses (COL) of the third processing unit group G3 or fourth processing unit group G4. Thereafter, the wafer W is coated with a resist film. Namely, a photosensitive film is formed thereon by the resist coating apparatus (COT) of the first processing unit group G1 or second processing unit group G2.

After forming the photosensitive film, thereon, the wafer W is subjected to heating process by the pre-baking apparatus (PREBAKE) of the third processing unit group G3 or fourth processing unit group G4 to evaporate and remove a residual solvent from the photosensitive film on the wafer W. The wafer W is cooled in the extension/cooling apparatus (EXTCOL) of the fourth processing unit group G4. The resultant wafer W is loaded onto the extension apparatus (EXT) of the fourth processing unit group G4. After that, the transfer mechanism 25 is carried from the opposite side, so that the wafer W is unloaded.

In connection with the unloaded wafer W, the wafer peripheral portion is subjected to peripheral exposing process by the peripheral exposure apparatus 24 (WEE).

A plurality of wafer Ws subjected to the peripheral exposure are sequentially contained in the buffer cassette (BUCR). Thereafter, when a reception signal is output from an exposure apparatus 13, the wafer Ws contained in the buffer cassette (BUCR) are sequentially transferred to the exposure apparatus by the transfer mechanism 25, and the transferred wafer Ws are sequentially subjected to exposing process.

When the exposure by this exposure apparatus is ended, the resultant wafer W is transferred to the main transfer mechanism 22 via the fourth processing unit group G4 in the reverse order relative to the aforementioned process. Then, the wafer W is transferred to the post exposure baking apparatus (PEB) by the main transfer mechanism 22. As a result, the wafer W is heated. The resultant wafer W is cooled to a predetermined temperature by the cooling apparatus (COL).

Next, the wafer W is transferred to the main transfer mechanism 22, and carried into the developing apparatus (DEV) of the first processing unit group G1 or second processing unit group G2, and the carried wafer W is developed by developing solution. After that, the resultant wafer W is washed off by a rinsing solution, and the developing process is completed.

Next, the wafer W is transferred from the developing apparatus (DEV) by the main transfer mechanism 22. The wafer W is heated in the post baking apparatus (POBAKE) of the third processing unit group G3 or fourth processing unit group G4, and cooled by the cooling apparatus (COL) of the third processing unit group G3 or fourth processing unit group G4. The resultant wafer W is placed in the extension apparatus (EXT) of the third processing unit group G3. Then, the wafer transfer mechanism 21 is carried from the opposite side, so that the wafer W is unloaded and carried onto the cassette C where the processed wafers are placed.

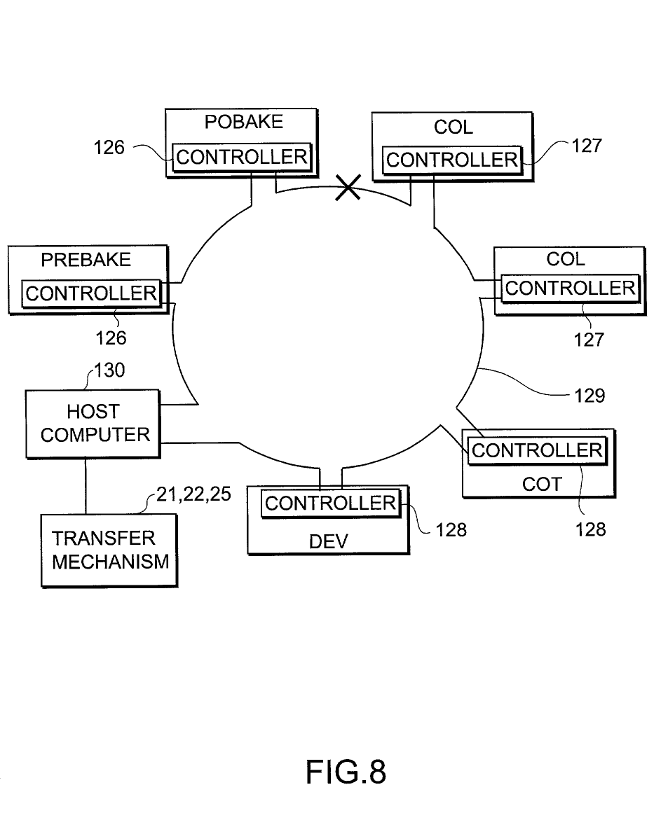

FIG. 8 is a view illustrating a control system in the aforementioned coating and developing processing system 1.

The pre-baking apparatus (PREBAKE), post baking apparatus (POBAKE), cooling apparatus (COL), resist coating apparatus (COT) and developing apparatus (DEV) (generically called “processing apparatuses”) have controllers 125, 126, 127 and 128, respectively, and they are connected to one another in a ring shape via a ring cable 129 together with a host computer 130 that entirely and generically controls the system.

The host computer 130 sends management data such as setting temperature, setting time, and so on to the respective controllers 125, 126, 127, and 128. These controllers 125, 126, 127, and 128 cause the processing apparatuses to execute the processes such as thermal processing, processing solution supply process, substrate tracking process, mechanical tracking process in the processing solution supply step, and the like based on management data.

Moreover, sensors for measuring temperature, pressure, and the like are provided in these processing apparatuses. Measurement data obtained by these sensors are used to control processes under the respective controllers 125, 126, 127, and 128. In addition, measurement data is transmitted to the host computer 130 via the controllers 125, 126, 127, and 128. The transmitted data is evaluated based on predetermined evaluation criteria. Then, the host computer 130 sends a parameter value, serving as a control command, for optimizing each process condition to each of the controllers 125, 126, 127, and 128 of the processing apparatuses based on the evaluation result.

On the other hand, the main wafer transfer mechanism 22, first and second wafer transfer mechanism 21 and 25 (generically called “transfer mechanism”) and second clean air supply mechanism 27 have no controller. Namely, they are directly connected to the host computer 130. That is, they are directly controlled to execute their operations by the host computer 130.

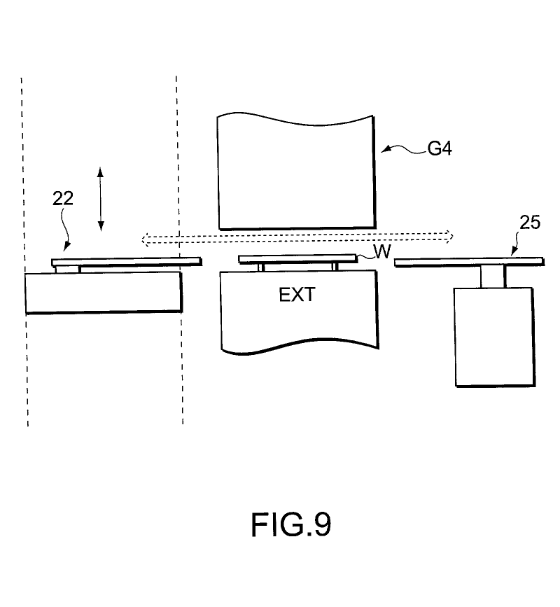

Accordingly, as illustrated in FIG. 9, though the transfer of wafer W between the main wafer transfer mechanism 22 and the second wafer transfer 25 is carried out via the extension apparatus (EXT) (delivery mechanism) of the fourth processing unit group G4, this transfer is directly controlled by the host computer 130 to execute the operation. The transfer of wafer W between the second wafer transfer mechanism 25 and the exposure apparatus 13 is also directly controlled by the host computer 130 to execute the operation.

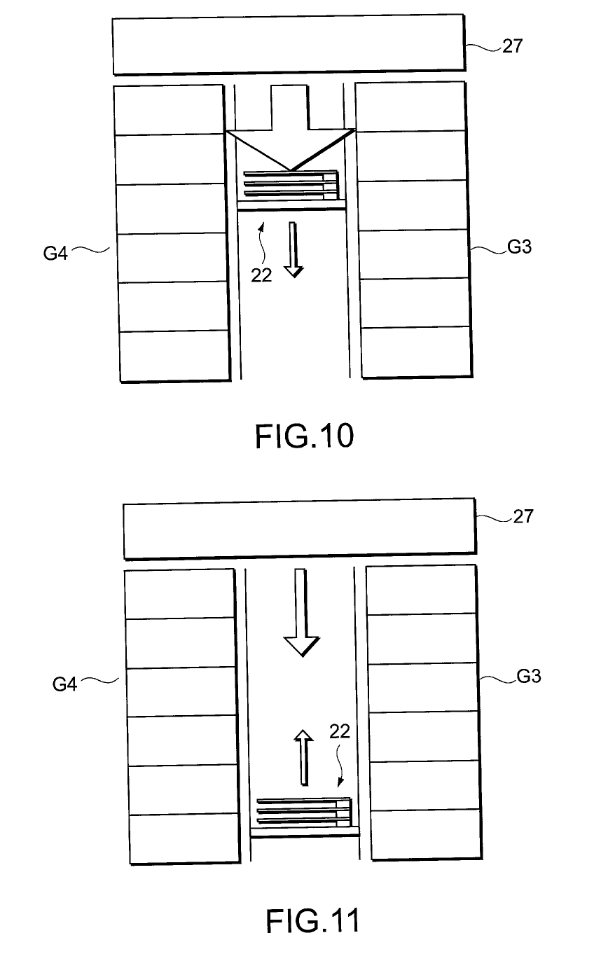

In the resist coating and developing system 1, as illustrated in FIG. 10, there is a case in which the main wafer transfer mechanism 22, which is placed just below the second clean air supply mechanism 27, transfers the wafer W toward a lower portion. In this case, a large amount of clear air is supplied toward the lower portion from the second clean air supply mechanism 27. As illustrated in FIG. 11, there is a case in which the main wafer transfer mechanism 22, which is placed right below the second clean air supply mechanism 27, transfers the wafer W toward an upper portion. In this case, a small amount of clean air is supplied toward the lower portion from the second clean air supply mechanism 27. Thus, the control of second clean air supply mechanism 27 maintains the peripheral air pressure of the main wafer transfer mechanism 22 constant and prevents particles from being scattered. Accordingly, the upper and the lower transfer of wafer W due to the main wafer transfer mechanism 22 must be controlled to be synchronized with the second clean air supply mechanism 27. For this reason, the second clean air supply mechanism 27 is directly controlled by the host computer 130 to execute the operation, similar to the main wafer transfer mechanism 22.

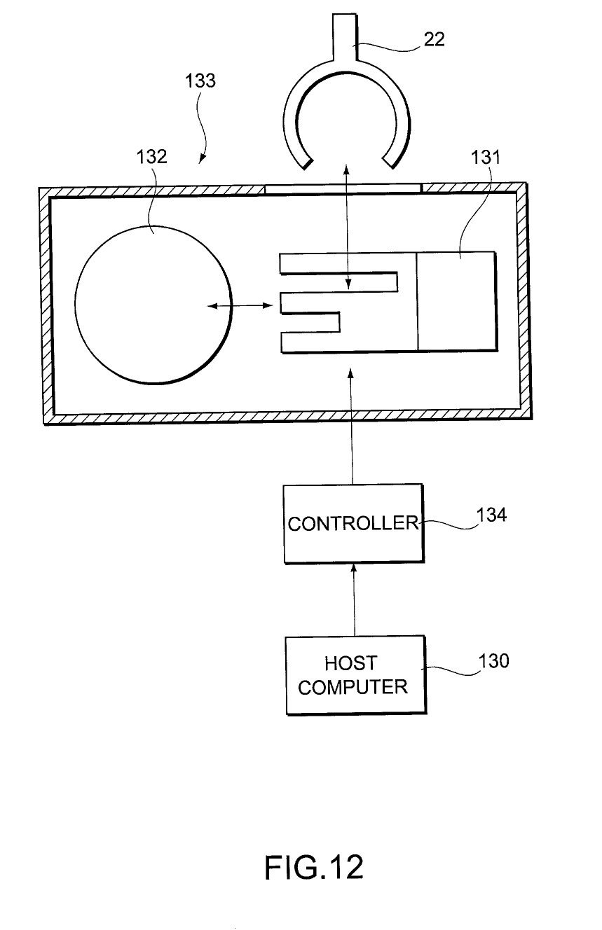

In the resist coating and developing system 1, there is sometimes used a heating apparatus 133, which comprises a cooling apparatus-equipped transfer mechanism 131 and a heat processing apparatus 132 as illustrated in FIG. 12, in place of the pre-baking apparatus (PREBAKE) and the post baking apparatus (POBAKE) shown in FIG. 6.

In the heating apparatus 133, for example, the cooling apparatus-equipped transfer mechanism 131 receives the wafer W from the main wafer transfer mechanism 22 and transfers and loads the wafer W onto the heat processing apparatus 132. The wafer W is subjected to heating process by the heat processing apparatus 132. The cooling apparatus-equipped transfer mechanism 131 receives the resultant wafer W from the heat processing apparatus 132 and transfers the wafer W as being cooled during the transfer, and loads the wafer W onto the main wafer transfer mechanism 22.

In the above-structured heating apparatus 133, the transfer of wafer W with the cooling apparatus-equipped transfer mechanism 131 is preferably controlled by a controller 134 provided in the heating apparatus 133 instead of directly controlling it by the host computer 130. This is because the transfer of wafer W due to the cooling apparatus-equipped transfer mechanism 131 performs not only the transfer of wafer W but also thermal processing to the wafer W. Namely, in such a case, the main wafer transfer mechanism 22, first and second wafer transfer mechanism 21 and 25, which are the apparatuses in the transfer system, are directly controlled by the host computer 130 to perform their operations. The cooling apparatus-equipped transfer mechanism 131 provided in the heating apparatus 133, the apparatuses in the transfer system, is controlled by the controller 134 to perform the operation.

Here, as illustrated in FIG. 8, there is a case in which the ring cable 129 is physically or electrically damaged (mark “X” in the figure) after sending an operation start command to the respective transfer mechanism 21, 22, and 25 from the host computer 130 or before receiving an operation end command or a case where one of processing apparatuses is broken down and is out of control may occur. In that case, the transfer mechanism 21, 22, and 25 stop the transfer of the substrate to each processing apparatus in response to the operation end command from the host computer 130 since they are directly connected to the host computer 130. This prevents the transfer mechanism 21, 22, and 25 from running away so that the processes are being carried out for the substrate safely without causing damage to each processing apparatus.

In the case where the cable for connecting the host computer 130 to the respective transfer mechanism 21, 22, and 25 is damaged, the transfer mechanism go down themselves, with the result that they do not run away. Accordingly, the processes for the substrate can be carried out safely.

Since the control system of each processing apparatus is independent of the host computer 130, it is possible to rearrange the processing apparatuses in the resist coating and developing system 1 without exerting an influence upon the host computer 130. On the other hand, since the transfer mechanisms form the main parts in the resist coating and developing system 1, the rearrangement of transfer mechanisms is hardly ever carried out. Accordingly, there is no problem even if they are made directly controlled by the host computer 130.

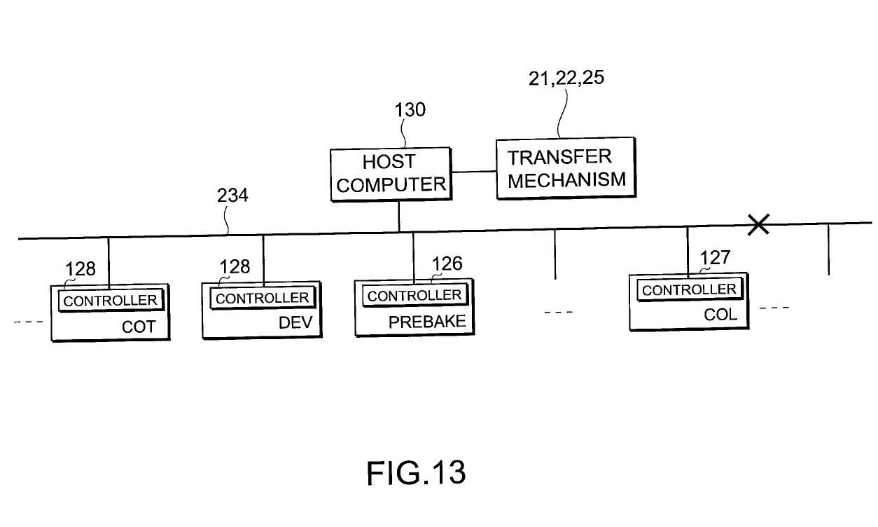

FIG. 13 is a structural view illustrating the control system of the second embodiment of the present invention where the ring-type structure shown in FIG. 8 is replaced with a bus-type structure. Note that, in this embodiment, the same reference numerals as those of the first embodiment are added to the same structural components as those of the first embodiment, and the explanation thereof is omitted.

In this embodiment, the pre-baking apparatus (PREBAKE), post baking apparatus (POBAKE), cooling apparatus (COL), resist coating apparatus (COT) and developing apparatus (DEV) (generically called “processing apparatuses”) have controllers 125, 126, 127, and 128, respectively according to the host computer 130, and they are connected to a bus cable 234 in a bus type manner. On the other hand, the main wafer transfer mechanism 22, first and second wafer transfer mechanism 21 and 25 having no controller (generically called “transfer mechanism”) are directly connected to the host computer 130. That is, they are directly controlled to perform their operations by the host computer 130.

Similar to the ring-type control system, in such a bus-type control system, in a case where the bus cable 234 is physically or electrically damaged after sending an operation start command to the respective transfer mechanism 21, 22, and 25 from the host computer 130 and before receiving an operation end command or in a case where one of the processing apparatuses is out of control, the transfer mechanism 21, 22, and 25 stop the transfer of the substrate to each processing apparatus in response to the operation end command from the host computer 130 since they are directly connected to the host computer 130. As a result, the transfer mechanism 21, 22, and 25 can be prevented from running away so that the processes for the substrate can be carried out safely without causing damage to each processing apparatus.

In the case where the cable for connecting the host computer 130 to the respective transfer mechanism 21, 22, and 25 is damaged, the transfer mechanisms go down themselves. As a result, they do not run away and the processes for substrate can be carried out safely.

Particularly, even if one of the processing apparatuses is broken down and is out of control, the transfer mechanism 21, 22, and 25 do not run away which means that the trouble does not have an adverse influence upon the other processing apparatuses.

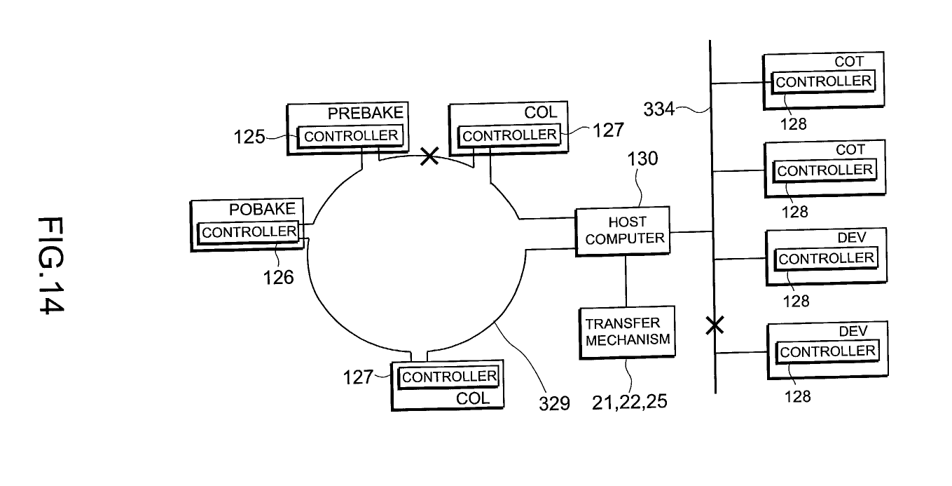

FIG. 14 is a structural view illustrating the control system of the third embodiment of the present invention. Note that, in this embodiment, the same reference numerals as those of the first and second embodiments are added to the same structural components as those of the first and second embodiments, and the explanation thereof is omitted.

In this embodiment, the host computer 130, entirely and generically controls the system. The units of thermal processing system as a plurality of first processing apparatuses that includes the pre-baking apparatus (PREBAKE), post baking apparatus (POBAKE), and cooling apparatus (COL) are connected to a ring cable 329 in a ring shape. The host computer 130, and the units of rotational coating process system as a plurality of second processing apparatuses including resist coating apparatus (COT), and developing apparatus (DEV) are connected to a bus cable 334. On the other hand, the transfer mechanism 21, 22, and 25 are directly connected to the computer 130, and they are controlled directly by the host computer 130.

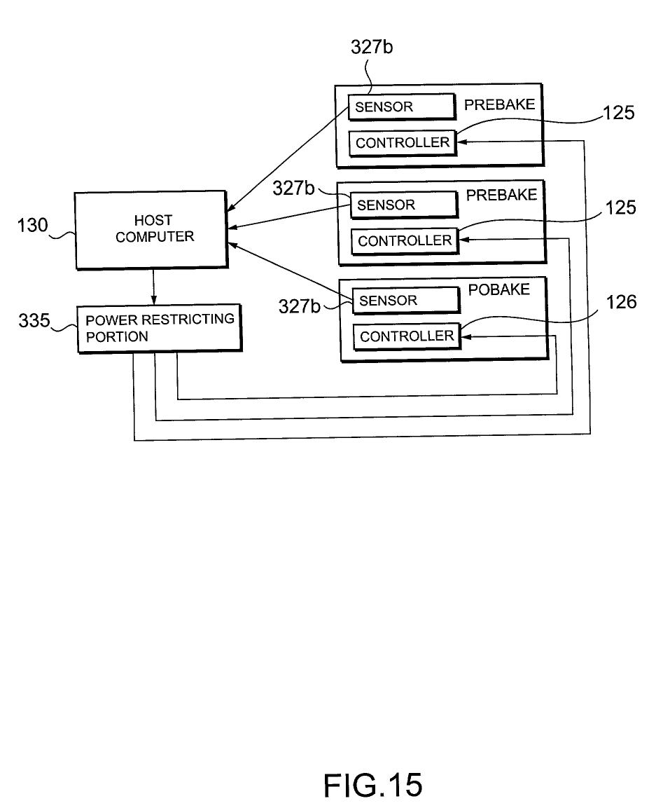

Furthermore, temperature sensors 327b (that measures, for example, the temperature of the heating plate 61 in FIG. 6) provided in the pre-baking apparatus (PREBAKE) and post baking apparatus (POBAKE) of the thermal processing system are directly connected to the host computer 130, respectively, as illustrated in FIG. 15. When the temperature sensor 327b detects an overheating of the heating plate 61, that is, the detected temperature exceeds the predetermined value, power supply is stopped by a power restricting portion 335 performing as restricting means for restricting the supply of power to the pre-baking apparatus (PREBAKE) and post baking apparatus (POBAKE). This power restricting portion 335 is designed to send a power stop command to the controller of each of the pre-baking apparatus (PREBAKE) and post baking apparatus (POBAKE). The structure enables the heating process in the pre-baking apparatus (PREBAKE) and post baking apparatus (POBAKE) to be carried out safely.

According to this embodiment, the second processing apparatuses, that is, the apparatuses of rotational coating system are connected in the bus type manner. For this reason, even if at least one of the apparatuses becomes out of control, the trouble does not have an adverse influence upon the other processing apparatuses. Particularly, the runaway of rotational operation can be prevented so that the processes can be carried out safely.

Moreover, the transfer mechanism 21, 22, and 25 are directly connected to the host computer 130 independently of the processing apparatuses of thermal system connected in the ring shape and the processing apparatuses of coating system connected in the bus-type manner. For this reason, even if the ring cable 329 or bas cable 334 is damaged there is no possibility that the transfer mechanism 21, 22, and 25 will run away to cause the damage to the respective processing apparatuses.

Note that the present invention is not limited to the above-explained embodiments.

For example, the above embodiment applied the present invention to the processing apparatus for the semiconductor wafer substrate. The present invention, however, can be applied to the processing apparatus for a glass substrate used in a liquid crystal display and the like.

Moreover, in place of the power restricting portion 335 of the third embodiment, a structure having a safety device such as a temperature fuse in each heat processing apparatus may be provided to reduce the load on the host computer 130.

As explained above, according to the present invention, the units of transfer system are directly connected to the host computer and directly controlled to perform their operations by the host computer. This enables to prevent the transfer mechanism from running away and to carry out the processes for substrate safely without causing damage to each processing apparatus.

The disclosure of Japanese Patent Application No.2000-316815 filed Oct. 17, 2000 including specification, drawings and claims are herein incorporated by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A system processing a substrate comprising:
at least one processing apparatus performing a predetermined process to the substrate;
a host computer controlling the system entirely and generically;
at least one controller, being provided corresponding to the processing apparatus and causes the processing apparatus to perform the process based on a request from the host computer; and
a transfer mechanism, being directly controlled by the host computer and loads/unloads the substrate to/from at least the processing apparatus.

2. The system according to claim 1, comprising:
a plurality of said processing apparatuses; and
a plurality of said controllers;
wherein each of said processing apparatuses is provided with each of said controllers.

3. The system according to claim 2,
wherein the host computer and the controllers are connected to one another in a ring shape, and the transfer mechanism is directly connected to the host computer.

4. The system according to claim 2,
wherein the controllers of the processing apparatuses are connected to the host computer in a bus shape, and the transfer mechanism is directly connected to the host computer.

5. A system processing a substrate comprising:
a plurality of first processing apparatuses supplying a predetermined solution onto the substrate while the substrate is being rotated;
a plurality of second processing apparatuses providing a thermal processing to the substrate;
a host computer controlling the system entirely and generically;
a plurality of first controllers, being provided corresponding to the first processing apparatuses and being connected to the host computer in a bus shape and causes the first processing apparatus to perform the process based on a request from the host computer;
a plurality of second controllers, being provided corresponding to the second processing apparatuses and being connected to the host computer in a ring shape and causes the second processing apparatus to perform the process based on a request from said host computer; and
a transfer mechanism, being directly controlled by the host computer and loads/unloads the substrate to/from at least the first and the second processing apparatuses.

6. The system according to claim 5,
wherein the second processing apparatuses provide a heating process to the substrate,
the system further comprising:
a sensor, being directly connected to the host computer and detects an overheating of the second processing apparatuses; and
a restricting means, being directly connected to the host computer and restricts power supply to the second processing apparatuses;
wherein the host computer controls the restricting means so that the power supply to the second processing apparatuses is restricted when the sensors detect the overheating.

7. A system processing a substrate comprising:
at least one processing apparatus performing a predetermined process to the substrate;
a first transfer mechanism transferring the substrate in the processing apparatus;
a host computer controlling the system entirely and generically;
a controller causing the first transfer mechanism to transfer the substrate based on a request from the host computer; and
a second transfer mechanism, being directly controlled by the host computer and loads/unloads the substrate to/from at least the processing apparatus.

8. A system processing a substrate, comprising:
a plurality of processing apparatuses performing a predetermined process to the substrate;
a plurality of transfer mechanisms, at least one of said plurality of transfer mechanisms transferring the substrate between the plurality of processing apparatuses;
a substrate delivery mechanism delivering the substrate between the plurality of transfer mechanism;
a host computer controlling the system entirely and generically; and
a plurality of controllers, being provided corresponding to the processing apparatuses and causes the processing apparatuses to perform the process based on a request from the host computer,
wherein the host computer directly controls the delivery of the substrate between the plurality of transfer mechanisms via the substrate delivery mechanism.

9. The system according to claim 8,
wherein at least one of said transfer mechanisms delivers the substrate to/from an outer section, and the host computer causes the transfer mechanism to directly control the delivery of the substrate to/from the outer section.

10. A system processing a substrate comprising:
a processing unit having a plurality of processing apparatuses stacked vertically and performing predetermined processes to the substrate;
a plurality of vertical transfer type transfer mechanisms, at least one of said plurality of transfer mechanisms transferring the substrate between said plurality of processing apparatuses;
a clean air supply mechanism, being provided at an upper portion of the transfer mechanism and supplying a clean air downward;
a host computer controlling the system entirely and generically; and
a plurality of controllers, being provided corresponding to the processing apparatuses and causes the processing apparatus to perform the process based on a request from the host computer,
wherein the host computer causes the transfer mechanisms and the clean air supply mechanism to directly control the transfer of the substrate and the supply of the clean air, respectively.

11. The system according to claim 10,
wherein the host computer controls the clean air supply mechanism to increase the supply of the clean air when the transfer mechanism transfers the substrate downward, and to decrease the supply of the clean air when the transfer mechanism transfers the substrate upward.
